(19) United States
(12) Patent Application Publication
(10) Pub. No.: US 2021/0367833 A1
(43) Pub. Date: Nov. 25, 2021

(54) INFORMATION PROCESSING APPARATUS THAT PROVIDES REQUIREMENT MANAGEMENT SERVICE, NETWORK SYSTEM, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: Hikaru Sugita, Ibaraki (JP)

(21) Appl. No.: 17/317,068

(22) Filed: May 11, 2021

(30) Foreign Application Priority Data
May 22, 2020 (JP) 2020-089732

(51) Int. Cl. H04L 12/24

(52) U.S. Cl. CPC H04L 41/08

(57) ABSTRACT

An information processing apparatus that facilitates attachment of a file to a ticket created by using a requirement management service. The information processing apparatus connects to a server that provides a requirement management service. A first acquisition unit acquires input items for creating a ticket, from the requirement management service. A setting unit sets parameters of the acquired setting items in accordance with a user operation. A generation unit generates a creation request for requesting creation of a ticket on which the set parameters are reflected. A second acquisition unit acquires data to be attached to the ticket as a file. A transmission unit transmits the creation request in a state having the acquired data attached thereto, to the server.

### BACKGROUND OF THE INVENTION

### Field of the Invention

The present invention relates to an information processing apparatus that provides a requirement management service, a network system, a method of controlling the information processing apparatus, and a storage medium, and more particularly to an information processing apparatus that provides a requirement management service on a cloud, a network system, a method of controlling the information processing apparatus, and a storage medium.

### Description of the Related Art

Along with proliferation of cloud computing, it is becoming a common practice to provide data and services in a cloud, so that users are enabled to edit data or receive services in the cloud instead of editing data or receiving services in a client terminal.

As one of services provided in a cloud, there is a requirement management service such as Jira (registered trademark). The requirement management service is a service in which a ticket of a requirement managed by a user is created using a remote user interface (RUI) displayed on an information terminal, and information, such as a summary and an expiration date of a requirement to be managed and a person in charge, is registered in the ticket. By using the requirement management service, a user is capable of visually grasping requirements which the user is in charge of and an administrator is capable of managing the progress of tickets based on degrees thereof. Further, in the requirement management service, a document used for a requirement under management can be attached to a ticket.

On the other hand, along with proliferation of cloud computing, for example, a service has been proposed in which an image formed by scanning by a multifunction peripheral (MFP) having a network communication function is transmitted via a network to a cloud and is stored therein (see Japanese Laid-Open Patent Publication (Kokai) No. 2018-98584). Through the use of this service, by setting a transmission destination to a ticket of a requirement management service, an image formed by scanning by the MFP can be attached to the ticket as a file.

However, in a case where an image formed by scanning is to be attached to a ticket created anew, as a file, the user is required to create the ticket in an information terminal and then transmit the image to be attached to the ticket, which has been formed by scanning, from the MFP to the requirement management service. Further, as the requirement management service, there are provided a plurality of types of services, and information that can be registered is different from one service to another, and hence, when performing such transmission, the user is sometimes required to change the information input for registration in association with a service used for creation of the ticket.

### SUMMARY OF THE INVENTION

The present invention provides an information processing apparatus that facilitates attachment of a file to a ticket created by using a requirement management service and thereby being capable of improving user convenience, a network system, a method of controlling the information processing apparatus, and a storage medium,

In a first aspect of the present invention, there is provided an information processing apparatus that connects to a server that provides a requirement management service, including a first acquisition unit configured to acquire input items for creating a ticket, from the requirement management service, a setting unit configured to set parameters of the acquired setting items in accordance with a user operation, a generation unit configured to generate a creation request for requesting creation of a ticket on which the parameters set by the setting unit are reflected, a second acquisition unit configured to acquire data to be attached to the ticket as a file, and a transmission unit configured to transmit the creation request in a state having the acquired data attached thereto, to the server.

In a second aspect of the present invention, there is provided an information processing apparatus that connects to a server that provides a requirement management service, including a first acquisition unit configured to acquire information on an existing ticket from the requirement management server, a changing unit configured to change parameters of the information on the existing ticket in accordance with a user operation, a generation unit configured to generate a creation request for requesting creation of a ticket on which the parameters changed by the changing unit are reflected, a second acquisition unit configured to acquire data to be attached to the ticket as a file, and a transmission unit configured to transmit the creation request in a state having the acquired data attached thereto, to the server.

In a third aspect of the present invention, there is provided a network system including a server that provides a requirement management service to an information terminal, and an information processing apparatus that executes transmission of a creation request for creating a ticket to the server, wherein the information processing apparatus includes a first acquisition unit configured to acquire input items for creating a ticket, from the requirement management service, a setting unit configured to set parameters of the acquired setting items in accordance with a user operation, a generation unit configured to generate a creation request for requesting creation of a ticket on which the parameters set by the setting unit are reflected, a second acquisition unit configured to acquire data to be attached to the ticket as a file, and a transmission unit configured to transmit the creation request in a state having the acquired data attached thereto, to the server, and wherein the requirement management service of the server includes creating the ticket in accordance with the creation request and attaching the data to the ticket as a file.

In a fourth aspect of the present invention, there is provided a method of controlling an information processing apparatus that connects to a server that provides a requirement management service, including acquiring input items for creating a ticket, from the requirement management service, setting parameters of the acquired setting items in accordance with a user operation, generating a creation request for requesting creation of a ticket on which the set parameters are reflected, acquiring data to be attached to the ticket as a file, and transmitting the creation request in a state having the acquired data attached thereto, to the server.

In a fifth aspect of the present invention, there is provided a method of controlling an information processing apparatus that connects to a server that provides a requirement management service, including acquiring information on an existing ticket from the requirement management server, changing parameters of the information on the existing ticket in accordance with a user operation, generating a creation request for requesting creation of a ticket on which the changed parameters are reflected, acquiring data to be attached to the ticket as a file, and transmitting the creation request in a state having the acquired data attached thereto, to the server.

According to the present invention, by facilitating attachment of a file to a ticket created by using a requirement management service, it is possible to improve user convenience.

Further features of the present invention will become apparent from the following description of exemplary embodiments (with reference to the attached drawings).

### BRIEF DESCRIPTION OF THE DRAWINGS

FIG. 1 is a diagram showing a network system including a multifunction peripheral (MFP) as an information processing apparatus according to first and second embodiments of the present invention.

FIG. 2 is a diagram showing a hardware configuration of the MFP.

FIG. 3 is a diagram showing a hardware configuration of a mobile terminal appearing in FIG. 1.

FIG. 4 is a diagram showing a hardware configuration of a requirement management server appearing in FIG. 1.

FIG. 5 is a diagram showing an operation screen displayed on a touch panel of a console section of the MFP shown in FIG. 2.

FIG. 6A is a diagram showing an application management screen displayed on the touch panel shown in FIG. 5.

FIG. 6B is a diagram showing a ticket creation application management screen displayed on the touch panel.

FIG. 6C is a diagram showing a new button registration screen displayed on the touch panel shown in FIG. 5.

FIGS. 7A and 7B are diagrams useful in explaining a new ticket creation process according to the first embodiment, which is started by depression of a ticket creation key appearing in FIG. 5.

FIG. 8 is a sequence diagram showing a ticket creation process performed between a requirement management server (requirement management service) and the MFP in the first embodiment.

FIG. 9 is a flowchart of a ticket creation process performed by the MFP in the first embodiment.

FIG. 10A is a diagram showing a requirement management service screen displayed on the mobile terminal, immediately before a user presses a “YES” button on a transmission execution screen shown in FIG. 7A.

FIG. 10B is a diagram showing a requirement management service screen displayed on the mobile terminal, immediately after the user presses the “YES” button on the transmission execution screen shown in FIG. 7A.

FIGS. 11A to 11C are diagrams useful in explaining an existing ticket changing process according to a second embodiment, which is started by depression of the ticket creation key appearing in FIG. 5.

FIG. 12A is a flowchart of a ticket creation process performed by the MFP in the second embodiment.

FIG. 12B is a continuation of FIG. 12A.

### DESCRIPTION OF THE EMBODIMENTS

The present invention will now be described in detail below with reference to the accompanying drawings showing embodiments thereof.

First and second embodiments of the present invention are described below by taking a multifunction peripheral (MFP) equipped with a print function, a scan function, and a FAX function, as an example of the information processing apparatus.

Note that the first and second embodiments described below do not limit the scope of claims of the present invention, and all combinations of features of the first and second embodiments, described below, are not necessarily essential to a solution of the invention.

First, the first embodiment of the present invention will be described.

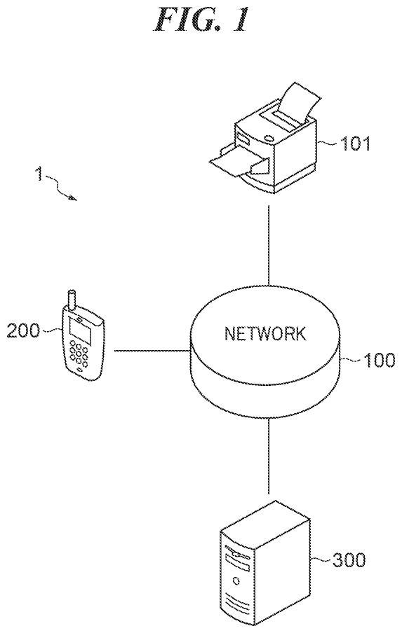

FIG. 1 is a block diagram of a network system 1 including the MFP, denoted by reference numeral 101, as the information processing apparatus according to the first embodiment.

Referring to FIG. 1, the network system 1 is comprised of a mobile terminal 200 (information terminal), the MFP 101 capable of transmitting image data via a network 100, and a requirement management server 300. The mobile terminal 200, the MFP 101, and the requirement management server 300 are connected to each other via the network 100 formed by the Internet, and are capable of communicating with each other.

The requirement management server 300 is a server that provides a requirement management service for performing creation and management of a ticket by receiving a ticket creation request from either the MFP 101 or the mobile terminal 200. Further, in a case where a received ticket creation request has image data attached thereto, the requirement management server 300 attaches the image data to the ticket as a file. Further, the requirement management server 300 displays tickets under management on the mobile terminal 200 in response to a user operation.

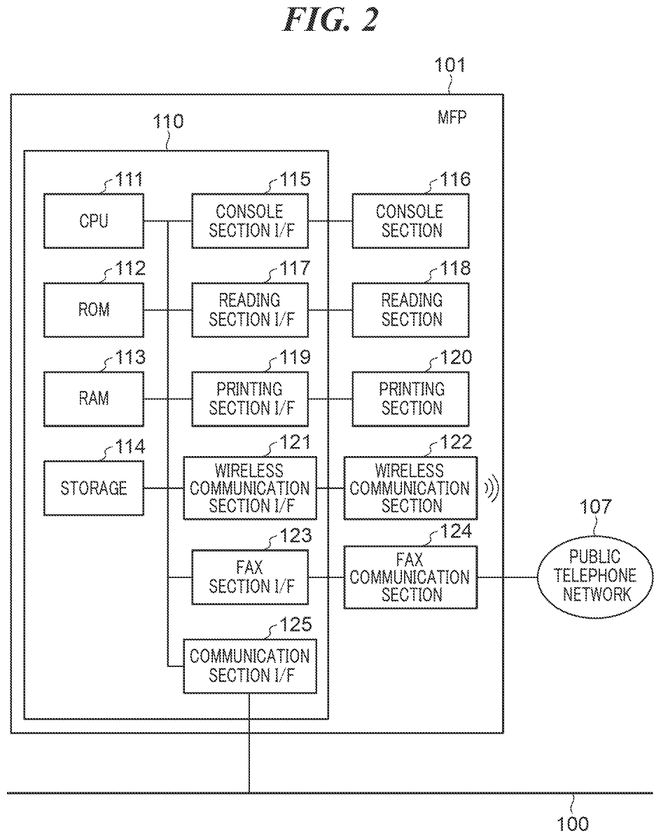

FIG. 2 is a block diagram showing a hardware configuration of the MFP 101.

Referring to FIG. 2, the MFP 101 is comprised of a controller 110 that is connected to the network 100 and controls the overall operation of the MFP 101, a console section 116, a reading section 118, a printing section 120, a wireless communication section 122, and a FAX communication section connected to a public telephone network 107.

The controller 110 includes a CPU 111, a ROM 112, a RAM 113, a storage 114, a console section interface 115, a reading section interface 117, a printing section interface 119, a wireless communication section interface 121, a FAX section interface 123, and a communication section interface 125.

The CPU 111 reads out control programs stored in the ROM 112 or the storage 114, for performing various kinds of control, such as reading control and printing control.

The ROM 112 stores the control programs executable by the CPU 111. The ROM 112 also stores a boot program, font data, and so forth.

The RAM 113 is a main memory for the CPU 111 and is used as a work area, a temporary storage area into which various control programs stored in the ROM 112 or the storage 114 are loaded, and so forth.

The storage 114 stores image data, print data, various control programs, and various kinds of setting information. In the present embodiment, it is assumed that a flash memory is as the storage 114, but an auxiliary storage device, such as an SSD, an HDD, and an eMMC, may be used.

Note that although in the MFP 101 in the present embodiment, the single CPU 111 executes various processes, described hereinafter with reference to flowcharts shown in figures, using the single memory (RAM 113), any suitable other form of execution of the processes may be employed. For example, a plurality of CPUs, RAMs, ROMs, and storages can be caused to cooperate to execute the processes. Further, part of the processes may be executed by using a hardware circuit, such as an ASIC or an FPGA.

The console section interface 115 connects between the console section 116 and the controller 110. The console section 116 displays information to a user and detects an input by the user.

The reading section interface 117 connects between the reading section 118 and the controller 110. The reading section 118 performs scan processing in which an image on a document is read and converted to image data, such as binary data. Image data generated by the reading section 118 is transmitted to an external apparatus, such as the requirement management server 300, or is printed on a recording sheet.

The printing section interface 119 connects between the printing section 120 and the controller 110. The CPU 111 transfers image data stored in the RAM 113 (image data to be printed) to the printing section 120 via the printing section interface 119. The printing section 120 prints the transferred image data on a recording sheet fed from a sheet feeder cassette of the printing section 120.

The wireless communication interface 121 is for controlling the wireless communication section 122 and connects between the controller 110 and an external wireless communication device via wireless.

The controller 110 controls the FAX communication section 124 via the FAX section interface 121 so as to be connected to the public telephone line 107. The FAX section interface 123 is for controlling the FAX communication section 124 and performs connection to the public telephone line 107, control of facsimile communication protocol, and so forth, using a facsimile communication modem incorporated therein, specifically by controlling a network control unit (NCU).

The communication section interface 125 connects between the controller 110 and the network 100. The communication section interface 125 transmits image data and various kinds of information inside the MFP 101 to external apparatuses, such as the requirement management server 300 on the network and the mobile terminal 200, and receives print data and various kinds of information inside the external apparatuses from the external apparatuses. Transmission and reception via the network 100 can be performed by a method using electric mails or a file transmission method based on another suitable protocol (e.g. FTP, WEBDAV, or the like). Further, the communication section interface 125 can transmit and receive image data and various kinds of setting data through access based on HTTP protocol from the requirement management server 300.

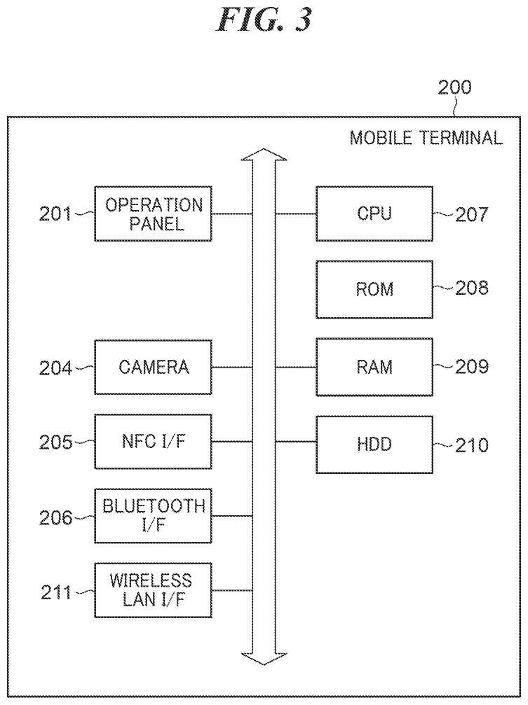

FIG. 3 is a diagram showing a hardware configuration of the mobile terminal 200. Note that it is assumed that a smart phone, a tablet PC, or the like apparatus is used as the mobile terminal 200 in the present embodiment, but any other suitable apparatus may be used insofar as it can communicate with the network 100.

Referring to FIG. 3, the mobile terminal 200 is comprised of an operation panel 201, a camera 204, a NFC interface 205, a Bluetooth interface 206, a CPU 207, a ROM 208, a RAM 209, an HDD 210, and a wireless LAN interface 211.

The CPU 207 reads out control programs stored in the ROM 208 and executes various processes for controlling the operation of the mobile terminal 200.

The ROM 208 stores the control programs.

The RAM 209 is a main memory for the CPU 207 and is used as a work area, a temporary storage area, and so forth.

The HDD 210 stores various kinds of data, such as images and electronic documents.

The operation panel 201 is equipped with a touch panel function capable of detecting a touch operation by a user, and displays various kinds of screen provided by an OS and an electronic mail transmission application. The user can input a desired operation instruction to the mobile terminal 200 by performing a touch operation on the operation panel 201. Note that the mobile terminal 200 is provided with hardware keys, not shown, and the user can also input an operation instruction to the mobile terminal 200 using associated ones of the hardware keys.

The camera 204 captures an image in response to an image capturing instruction given by the user. The image captured by the camera 204 is stored in a predetermined area of the HDD 210. Further, it is possible to acquire information from a QR code read by the camera 204, using a program capable of QR code analysis.

The mobile terminal 200 performs transmission and reception of data to and from an apparatus therearound, such as the MFP 101, via a communication interface, such as the NFC interface 205, the Bluetooth interface 206, or the wireless LAN interface 211. Further, the mobile terminal 200 connects to the network 100 as well via the communication interface and performs transmission and reception of data to and from external apparatuses, such as the MFP 101 and the requirement management server 300.

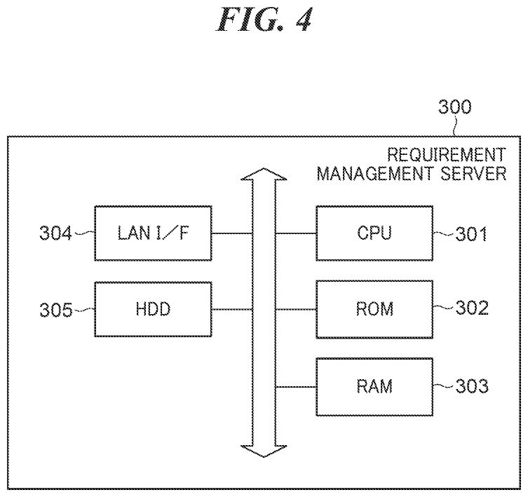

FIG. 4 is a diagram showing a hardware configuration of the requirement management server 300.

Referring to FIG. 4, the requirement management server 300 is comprised of a CPU 301, a ROM 302, a RAM 303, a LAN interface 304, and an HDD 305.

The CPU 301 reads out control programs stored in the ROM 302 and performs various processes for controlling the operation of the requirement management server 300.

The ROM 302 stores the control programs.

The RAM 302 is a main memory for the CPU 301 and is used as a work area, a temporary storage area, and so forth.

The HDD 305 stores data, such as ticket information and images.

The requirement management server 300 connects to the network 100 via the LAN interface 304 and performs transmission and reception of data to and from external apparatuses, such as the mobile terminal 200 and the MFP 101.

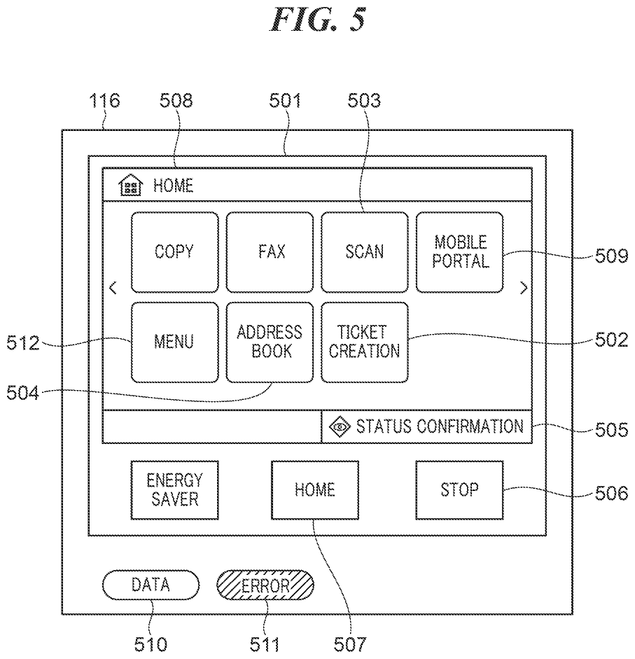

FIG. 5 is a diagram showing an operation screen displayed on the touch panel 501 of the console section 116 of the MFP 101.

The console section 116 includes a touch panel 501 that displays an operation screen, and LEDs 510 and 511.

The touch panel 501 functions not only as display means for displaying an operation screen, but also as reception means for receiving an instruction from a user. The user directly touches the operation screen on the touch panel using a finger or an object such as a stylus to instruct execution of functions. A shown in FIG. 5, the touch panel 501 displays STOP 506, HOME 507, a home screen 508, and so forth.

The home screen 508 is an initial screen via which a user instructs execution of functions of the MFP 101. Specifically, the home screen 508 is a screen for selecting between screens to be displayed for setting various settings of functions executed by the MFP 101, such as copy, facsimile, scan, and media print. More specifically, the home screen 508 displays a ticket creation key 502, a scan key 503, an address book key 504, a status confirmation key 505, a mobile portal key 509, and a menu key 512.

The status confirmation key 505 display a screen (status confirmation screen) for confirming a status of the MFP 101 in response to a user depression thereof. A transmission history can be displayed on the status confirmation screen. Note that in the present embodiment, when a user touches any of the keys in a key display area on the touch panel 501 using the object, the console section 116 detects depression of the key.

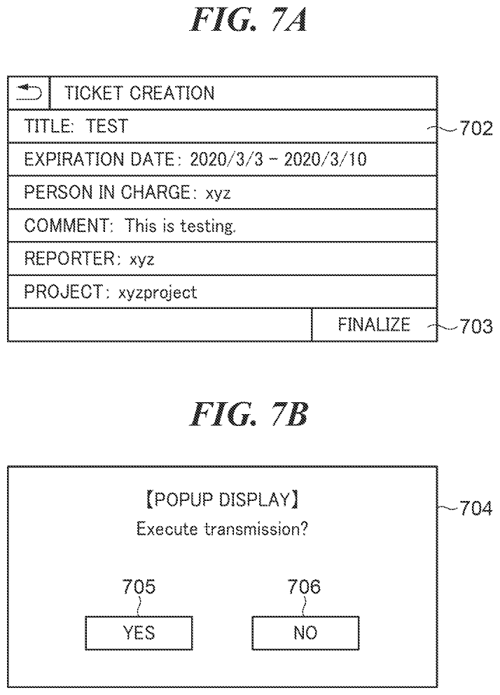

The ticket creation key 502 is responsive to a user depression for displaying a ticket information input screen 702, described hereinafter, with reference to FIG. 7A.

The scan key 503 is responsive to a user depression for displaying a scan selection screen (not shown). The scan selection screen displays an “email” key, a “file transmission” key for performing file transmission by any of SMB, FTP, and HTTP, and an “I FAX” key for performing internet facsimile transmission. Each of these keys sets transmission means indicated by the key as transmission means for transmitting image data generated by the reading section 118 to a destination and displays a transmission setting screen for setting a resolution of the image data at the time of transmission, an address of the destination, and so forth.

The address book key 504 is responsive to a user depression for displaying an address book screen (not shown) of the MFP 101.

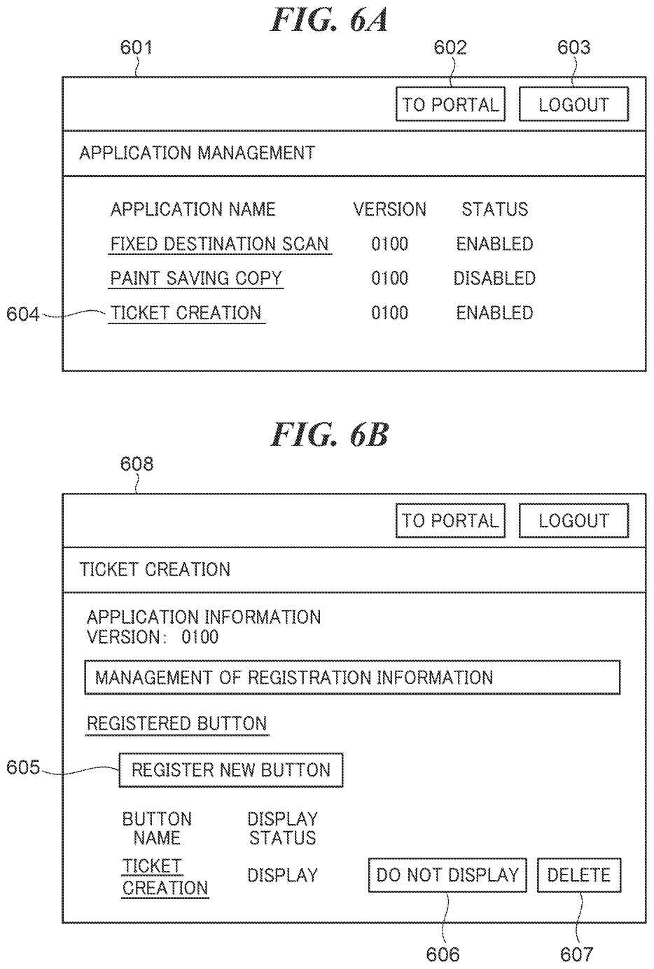

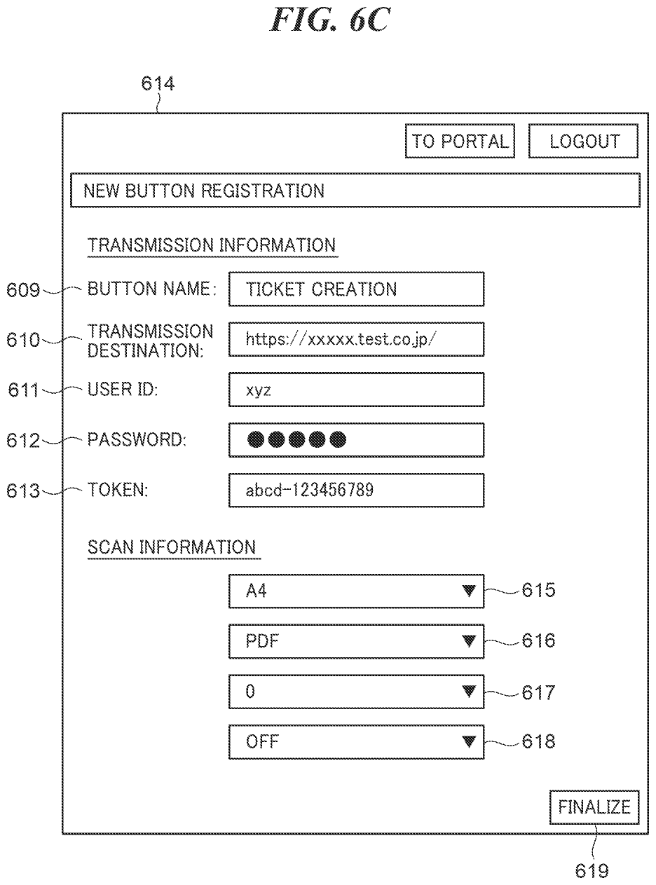

The mobile portal key 509 is used for accessing the requirement management server 300 to display a home screen of a remote UI (RUI). The home screen of the RUI includes “application management” which is a key for changing the screen to an application management screen 601, described hereinafter with reference to FIG. 6A. Note that when a user depression of the mobile portal key 509 occurs, first, a login screen for logging into the RUI is displayed on the touch panel 501. When the user inputs user information, such as a user ID and a password, to the login screen, the CPU 111 transmits a user authentication request including the user information to the requirement management server 300. When user authentication responsive to the user authentication request to the requirement management server 300 is successful, information on the home screen of the RUI is transmitted to the MFP 101. As a result, the home screen on the touch panel 501 is switched to the home screen of the RUI.

The LEDs 510 and 511 notify states of the MFP 101 to the user. Specifically, the LED 510 is lighted during reception of an electronic mail or execution of a print job, while the LED 511 is lighted when an error occurs in the MFP 101.

The STOP 506 is responsive to a user depression for cancelling operations on the MFP 101 and is always displayed as a resident key on the touch panel 501.

The HOME 507 is responsive to a user depression for displaying the home screen 508 and is always displayed as a resident key on the touch panel 501.

The menu key 512 is responsive to a user depression for displaying a screen for setting environment settings, such as a language for use, and settings of functions.

Now, the flow of screen changes of the RUI for creating the ticket creation key 502 displayed on the touch panel 501 will be described with reference to FIGS. 6A to 6C.

The application management screen 601 is displayed, as described above, after the mobile portal key 509 is depressed and when the key of “application management” is depressed on the home screen of the RUI which is displayed when the user authentication is successful. The application management screen 601 displays a list of buttons for changing the screen to respective screens for managing fixed destination scan, paint saving copy, and ticket creation, which are applications associated with respective keys displayed on the home screen 508. Further, the application management screen 601 includes a portal button 602 and a logout button 603.

The portal button 602 is for changing the screen from the application management screen 601 to the home screen of the RUI from which the screen was changed.

The logout button 603 is responsive to a user depression for logging out from the RUI.

The ticket creation button 604 is responsive to a user depression for changing the application management screen 601 to a ticket creation application management screen 608 (FIG. 6B).

Referring to FIG. 6B, the ticket creation application management screen 608 is a screen on which registration of a ticket creation key 502 and display, non-display, or deletion of the ticket creation key 502 on the touch panel 501 are executed. The ticket creation application management screen 608 includes buttons 605 to 607.

The button 605 is responsive to a user depression for changing the ticket creation application management screen 608 to a new button registration screen 614 (FIG. 6C).

The button 606 is responsive to a user depression for causing the ticket creation key 502 displayed on the home screen 508 not to be displayed on the same.

The button 607 is responsive to a user depression for deleting the ticket creation button registered on the ticket creation application management screen 608.

Referring to FIG. 6C, the new button registration screen 614 is provided with input boxes 609 to 613 for inputting transmission information and list boxes 615 to 618 for setting scan information. Here, the transmission information refers to transmission settings for transmitting a ticket creation request to the requirement management server 300. Further, the scan information refers to reading settings applied to the reading section 118 when generating image data to be attached to a ticket created in the requirement management server 300 according to the ticket creation request, as a file.

The input box 609 is for entering a name (button name) to be displayed on the home screen 508, and in the present example, “ticket creation” has been designated as an input of the button name in advance.

The input box 610 is for entering a destination of transmission of the ticket creation request, which is executed in response to depression of the ticket creation key 502, and in the present example, the requirement management server 300 has been designated as an input of the destination in advance.

The input box 611 is for entering an user ID to be included in the ticket creation request, and in the present example, the user ID entered in the login screen displayed when the mobile portal key 509 was depressed has been designated as an input of the user ID in advance.

The input box 612 is for entering a password to be included in the ticket creation request, and in the present embodiment, the password entered in the login screen displayed when the mobile portal key 509 was depressed has been designated as an input of the password in advance.

The input box 613 is for entering token (authentication) information to be included in the ticket creation request, and in the present embodiment, the token information has been designated in accordance with depression of the button 605.

The list box 615 is for setting a reading size for scan processing to be executed by depression of the ticket creation key 502.

The list box 616 is for setting a file format for scan processing.

The list box 617 is for setting a density for scan processing.

The list box 618 is for setting a document type for scan processing, and when ON is set, the document type is set to a double-sided document, whereas when OFF is set, the document type is set to a single-sided document.

A finalize button 619 is responsive to a user depression for registering the ticket creation key 502 on which the settings in the input boxes 609 to 613 and the list boxes 615 to 618 are reflected.

The new ticket creation process according to the present embodiment, which is started by depression of the ticket creation key 502, will be described with reference to FIGS. 7A and 7B.

When the ticket creation key 502 on the home screen 508 appearing in FIG. 5 is depressed by the user, the screen is changed to the ticket information input screen 702 shown in FIG. 7A.

On the ticket information input screen 702, the user is capable of entering parameters of setting items of ticket information of a ticket to be created anew, such as a title, an expiration date, a person in charge, a comment, a reporter, and a project. When a project is designated, a ticket associated with the project is generated by the requirement management server 300.

Further, the ticket information input screen 702 includes a finalize button 703, and when the user depresses the finalize button 703, a ticket on which the input parameters of setting items on the ticket information input screen 702 are reflected is created and the screen is changed to a transmission execution screen 704 shown in FIG. 7B.

The transmission execution screen 704 includes a YES button 705 and a NO button 706.

The YES button 706 is responsive to a user depression for executing transmission of a ticket creation request. Note that in a case where a document is set on the reading section 118 at this time, scan processing configured on the new button registration screen 614 is executed.

The NO button 705 is responsive to a user depression for terminating the new ticket creation process without executing transmission of the ticket creation request. In this case, the screen is changed from the transmission execution screen 704 to a transmission failure screen.

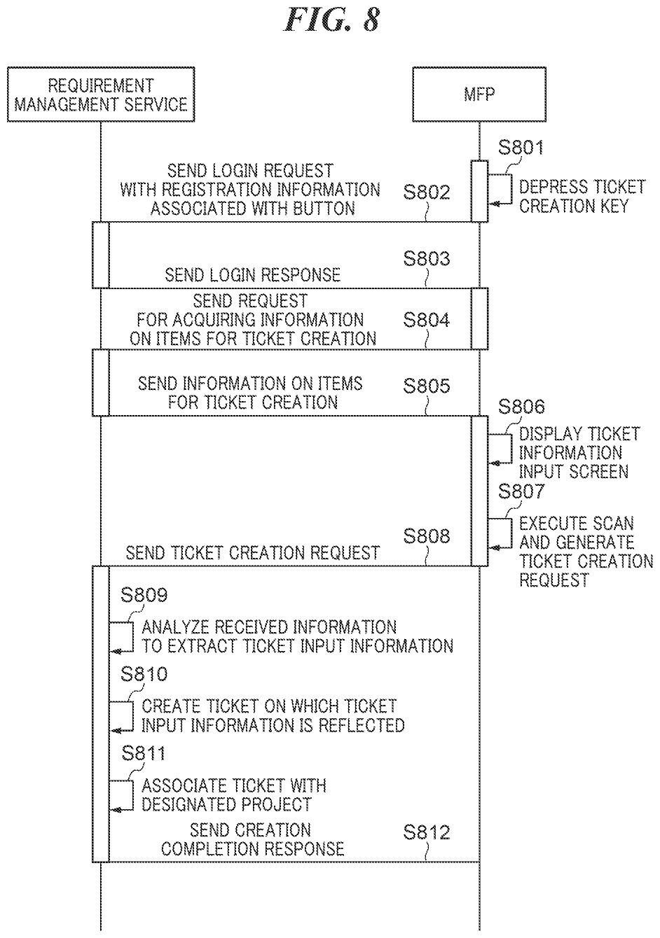

FIG. 8 is a sequence diagram of the ticket creation process performed by the MFP 101 and the requirement management server 300. Note that operations (steps) of the present process by the MFP 101 are performed by the CPU 111 executing a control program loaded from the ROM 112 or the storage 114 into the RAM 113. Similarly, operations (steps) of the present process by the requirement management server 300 are performed by the CPU 301 executing a control program loaded from the ROM 302 into the RAM 303.

First, when the ticket creation key 502 is depressed by the user in a step S801, the CPU 111 proceeds to a step S802 to send a login request with a user ID and a password which are settings set on the new button registration screen 614, to the requirement management server 300.

In a step S803, the CPU 301 of the requirement management server 300 sends a login response to the MFP 101. Note that in the illustrated example in FIG. 8, a description is given only on a case where a login response indicating successful login is sent to the MFP 101.

In a step S804, the CPU 111 sends a request for acquiring information on input items for ticket creation to the requirement management server 300.

In a step S805, the CPU 301 sends the information on the input items for ticket creation to the MFP 101.

In a step S806, the CPU 111 displays the ticket information input screen 702 based on the information acquired in the step S805. Thereafter, when the finalize button 703 is depressed by the user, the CPU 111 proceeds to a step S807.

In the step S807, the CPU 111 displays the transmission execution screen 704. Thereafter, when the YES button 705 is depressed by the user, the scan processing configured on the new button registration screen 614 is executed to acquire image data. Further, a ticket creation request is generated based on the parameters of setting items entered on the ticket information input screen 702 by the user in the step S806. Further, the CPU 111 acquires transmission information including a transmission destination (the requirement management server 300) and token information set on the new button registration screen 614.

In a step S808, the CPU 111 transmits a ticket creation request by attaching the image data acquired in the step S807 thereto, based on the transmission information acquired in the same step S807.

In a step S809, the CPU 301 extracts ticket input information from the received ticket creation request. In the present example, the parameters of setting items entered on the ticket information input screen 702 by the user in the step S806 are acquired as the ticket input information.

In a step S810, the CPU 301 creates a ticket on which the ticket input information extracted in the step S809 is reflected. Further, the CPU 301 stores the image data attached to the ticket creation request in the HDD 305 as a file and attaches the file to the generated ticket.

In a step S811, the CPU 301 associates the generated ticket with the project included in the ticket input information.

In a step S812, the CPU 301 sends a response notifying completion of ticket creation to the MFP 101, followed by terminating the present process.

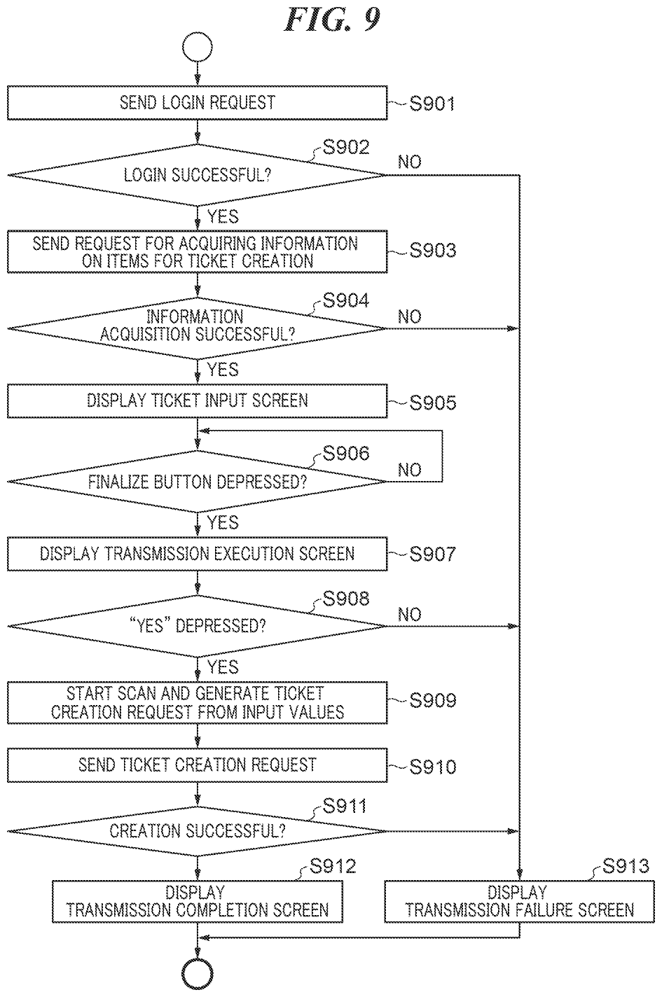

FIG. 9 is a flowchart of the ticket creation process performed by the MFP 101 in the present embodiment. Note that operations (steps) of this ticket creation process are performed by the CPU 111 executing the control program loaded from the ROM 112 or the storage 114 into the RAM 113.

In a step S901, when the ticket creation key 502 is depressed by the user, the CPU 111 sends a login request with the settings set on the new button registration screen 614 to the requirement management server 300 via the network 100.

In a step S902, the CPU 111 receives the login response from the requirement management server 300. In a case where the received login response indicates a successful login, the CPU 111 proceeds to a step S903 whereas in a case where the received login response indicates an unsuccessful login, the CPU 111 proceeds to a step S913.

In the step S903, the CPU 111 sends a request for information on input items for ticket creation to the requirement management server 300 via the network 100 and proceeds to a step S904.

In the step S904, the CPU 111 waits for a response to the request sent in the step S903 for a predetermined time period. In a case where the response is received, the CPU 111 determines that acquisition of information on the input items for ticket creation is successful and proceeds to a step S905, whereas in a case where no response is received even after the lapse of the predetermined time period, it is determined that the acquisition of information on the input items for ticket creation is unsuccessful, and the CPU 111 proceeds to the step S913.

In the step S905, the CPU 111 displays the ticket information input screen 702 on the touch panel 501 based the information successfully acquired in the step S904, and the proceeds to a step S906. Note that as described hereinbefore with reference to FIG. 7A, the user inputs parameters of various setting items of ticket information on the ticket information input screen 702.

In the step S906, the CPU 111 determines whether or not the finalize button 703 on the ticket information input screen 702 is depressed by the user. If the finalize button 703 is depressed, the CPU 111 proceeds to a step S907.

In the step S907, the CPU 111 displays the transmission execution screen 704 on the touch panel 501.

In the step S908, the CPU 111 determines whether or not the YES button 705 has been depressed by the user. In a case where the YES button 705 has been depressed by the user, the CPU 111 proceeds to a step S909, whereas in a case where the NO button 706 has been depressed by the user, the CPU 111 proceeds to the step S913.

In the step S909, the CPU 111 starts the scan processing configured on the new button registration screen 614 on a document set on the reading section 118 to thereby acquire image data. Further, the CPU 111 generates a ticket creation request based on the parameters of various setting items input in the step S905. Then, the CPU 111 proceeds to a step S910.

In the step S910, the CPU 111 attaches the image data acquired in the step S909 to the ticket creation request generated in the same step S909 and sends the ticket creation request to the requirement management server 300. Then, the CPU 111 proceeds to a step S911.

In the step S911, the CPU 111 waits for a response notifying completion of ticket creation from the requirement management server 300 for a predetermined time period. In a case where the response is received, the CPU 111 determines that the ticket creation is successful and proceeds to a step S912, whereas in a case where the no response is received even after the lapse of the predetermined time period, the CPU 111 determines that the ticket creation is unsuccessful and proceeds to the step S913.

In the step S912, the CPU 111 displays a transmission completion screen, followed by terminating the present process.

In the step S913, the CPU 111 displays a transmission failure screen, followed by terminating the present process.

Next, screens displayed on the operation panel 201 of the mobile terminal 200 will be described.

Similar to the home screen 508 of the MFP 101, the home screen of the operation panel 201 of the mobile terminal 200 also includes a “mobile portal” key for accessing the requirement management server 300 to display the home screen of the RUI. When the “mobile portal” key is depressed by the user, first, the login screen used for login to the RUI is displayed on the operation panel 201. When the user inputs user information, such as a user ID (“xyz” in the present example) and a password, to the login screen, the CPU 207 sends a user authentication request including the user information to the requirement management server 300. When user authentication performed by the requirement management server 300 in response to the user authentication request is successful, information on the home screen of the RUI is transmitted from the requirement management server 300 to the mobile terminal 200. As a result, the home screen of the operation panel 201 is changed to the home screen of the RUI.

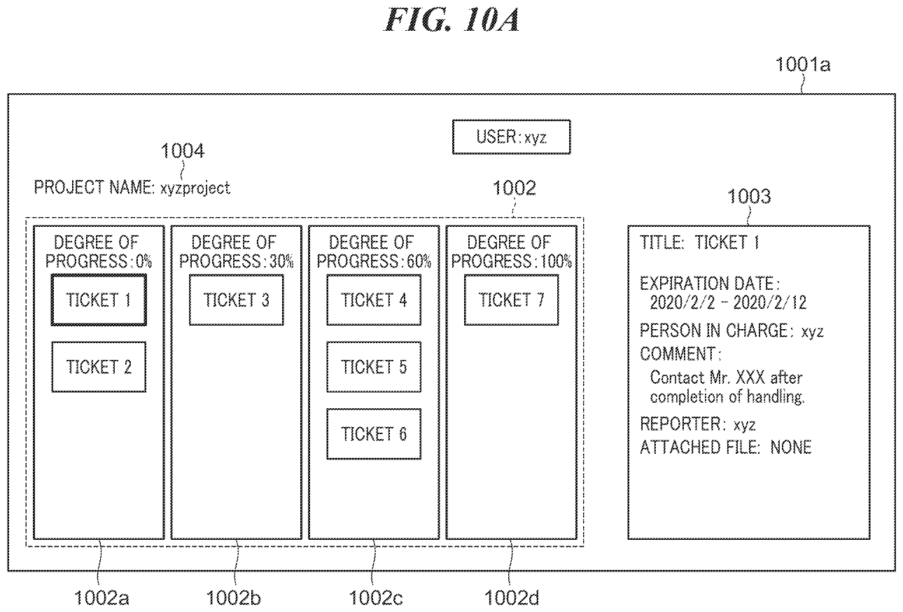

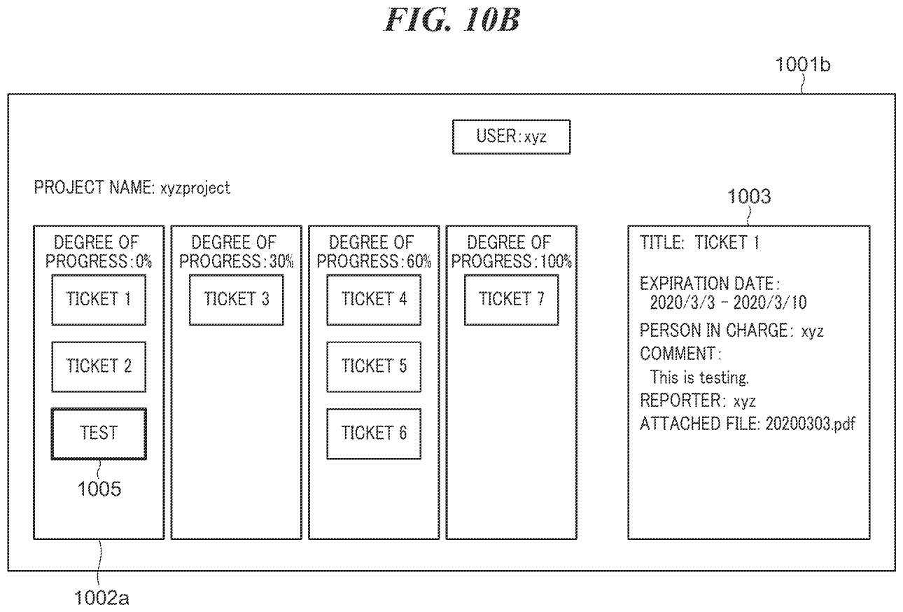

Thereafter, when an “requirement management” key included in the home screen of the RUI is depressed by the user, the home screen of the RUI is changed to a requirement management service screen 1001a, described hereinafter with reference to FIG. 10A.

With reference to FIGS. 10A and 10B, the requirement management service screen 1001a and a requirement management service screen 1001b will be described, respectively.

The present example shows a case where the user having an user ID of “xyz” is associated with only a project named “xyzproject”, but this is not limitative. For example, in a case where a user is associated with a plurality of projects, the box 1004 indicating a project name may be provided as a list box to thereby enable the user to select another project.

As shown in FIG. 10A, the requirement management service screen 1001a includes a progress area 1002 and a detailed information area 1003.

The progress area 1002 is for indicating degrees of progress of tickets associated with the project named “xyzproject”.

The detailed information area 1003 is for showing detailed information on a selected one of respective icons of the tickets shown in the progress area 1002.

The progress area 1002 includes an area 1002a indicating a degree of progress of 0%, an area 1002b indicating a degree of progress of 30%, an area 1002c indicating a degree of progress of 60%, an area 1002d indicating a degree of progress of 100%. Here, the requirement management server 300 sets the degree of progress of a ticket created anew to 0%.

In a case where the user is an administrator, the user can move tickets in the progress area 1002 to any of the areas 1002a to 1002d according to the respective degrees of progress of the tickets. This makes it possible to manage the state of the progress of each ticket. Note that a method of moving a ticket in the progress area 1002 is not particularly limited. For example, after determining that any of the icons of tickets in the progress area 1002 has reached a predetermined degree of progress, the administrator may move the icon by drag-and-drop. Also, upon detection of a long press of any of the icons of tickets in the progress area 1002, the CPU 111 may display an input field for the degree of progress of the ticket and move the icon according to a value of the degree of progress entered in the input field.

Note that in a case where one of the icons of tickets in the progress area 1002 is moved as described above, the requirement management server 3000 updates the degree of progress of the ticket to a degree indicated by an area to which the icon is moved.

The ticket having a degree of progress of 100% is a ticket of a requirement under management which is completed. Such a ticket continues to be displayed in the area 1002d indicating the degree of progress of 100%, but it is also possible to delete the same by a user operation.

As shown in FIG. 10A, when one of the tickets in the progress area 1002 (ticket 1 in the illustrated example) is selected by the user, the detailed information on the selected ticket is displayed on the detailed information area 1003.

As the expiration date input to each ticket in the progress area 1002 approaches, the requirement management server 300 cautions the user by changing the color of the ticket in the requirement management service area 1001a or by sending an electronic mail notice to the user.

When the user depresses the “YES” button 705 on the transmission execution screen 704 (FIG. 7B) of the MFP 101 and the requirement management server 300 generates a ticket anew, the requirement management service screen 1001a is changed to a requirement management service screen 1000b (FIG. 10B).

In an area 1002a in FIG. 10B, which indicates a degree of progress of 0%, a box 1005 indicating “Test” ticket is displayed anew. Further, the detailed information area 1003 displays ticket information on which parameters input by the user on the ticket information input screen 702 of the MFP 101 are reflected and information on image data attached to the ticket, which was acquired by scan processing executed by a user depression of the YES button 705. This makes it unnecessary for the user to refer to image data stored in a different location, such as a shared folder, but enables the user to check whether or not image data has been attached to the “Test” ticket only by checking the detailed information of the “Test” ticket on the detailed information area 1003.

As described above, according to the present embodiment, by using the MFP 101, the user can perform creation of a ticket and attachment of a file to the ticket with ease.

Next, a second embodiment of the present invention will be described.

In the present embodiment, a ticket is created anew based on ticket information on which parameters input by a user in the MFP 101 are reflected, and image data acquired by scan processing by the MFP 101 is attached to the ticket as a file. In contrast, in the second embodiment, ticket information of the existing ticket is changed by a user operation on the MFP 101 and image data acquired by scan processing by the MFP 101 is attached to the changed ticket as a file anew.

Hereafter, the same components as the those of the first embodiment are denoted by the same reference numerals and redundant description thereof is omitted.

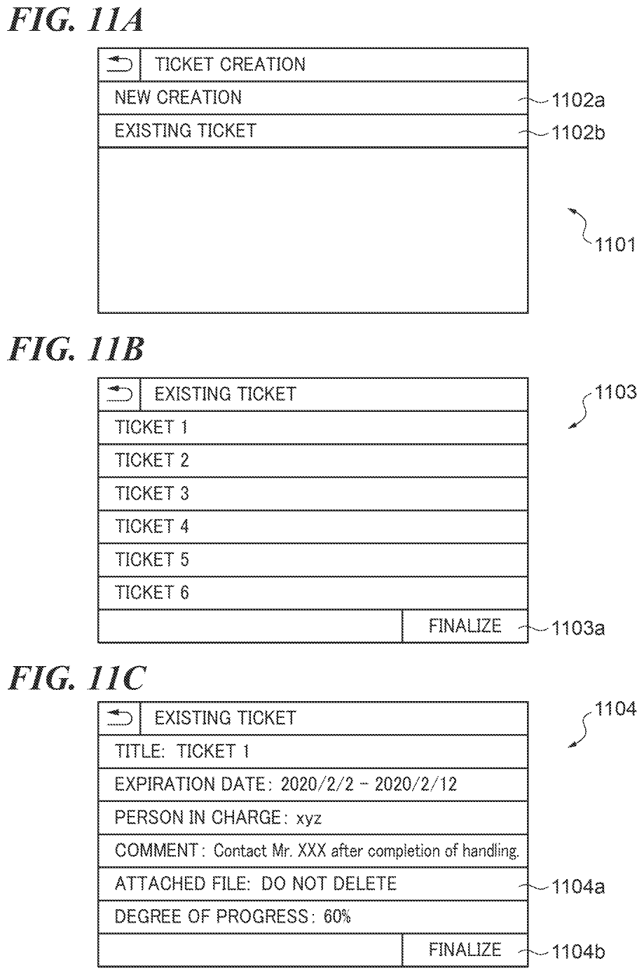

A flow of an existing ticket changing process started by depression of the ticket creation key 502 will be described with reference to FIG. 11. Note that the same screen elements as those of the first embodiment have the same reference numerals assigned thereto.

When the ticket creation key 502 is depressed by the user on the home screen 508 in FIG. 5, the screen is changed to a ticket selection screen 1101 shown in FIG. 11A.

The ticket selection screen 1101 includes the two keys of a new creation 1102a and an existing ticket 1102b.

The new creation 1102a is a key responsive to a user depression for changing the screen to the ticket information input screen 702.

The existing ticket 1102b is a key responsive to a user depression for changing the screen to an existing ticket screen 1103.

The existing ticket screen 1103 displays a list of tickets which the user registered on the new button registration screen 614 (FIG. 6C). When the user selects one of the tickets of the displayed list and then depresses a finalize button 1103a, the screen is changed to an existing ticket information input screen 1104 (FIG. 11C)

The existing ticket information input screen 1104 displays parameters of setting items included in the ticket information of a ticket (ticket 1 in the illustrated example) selected by the user on the existing ticket screen 1103, in advance, such that the parameters can be changed by the user. Note that the existing ticket information input screen 1104 may also display parameters of setting items different from the ticket information of the newly created ticket, including a current degree of progress, such that they can be changed by the user.

Further, in a case where a file has been attached as in the case of ticket 1, as shown in FIG. 11C, “do note delete” is displayed in advance as a setting item 1104a of “attached file”. In this case, a file is additionally attached to the ticket 1 by scan processing. Note that the setting item 1104a is in the form of a list box and the user is also capable of changing the setting item 1104a from “do note delete” to “delete”. In a case where the setting item 1104a is changed to “delete”, the file already attached to ticket 1 is deleted therefrom and image data acquired by scan processing is attached to ticket 1 as a file.

When the finalize button 1104b is depressed, the screen is changed to the transmission execution screen 704 (FIG. 7B). As described hereinabove with reference to FIG. 7B, depression of the YES button 705 by the user causes execution of transmission of the ticket creation request. Note that in a case where a document is set on the reading section 118, scan processing configured on the new button registration screen 614 is executed.

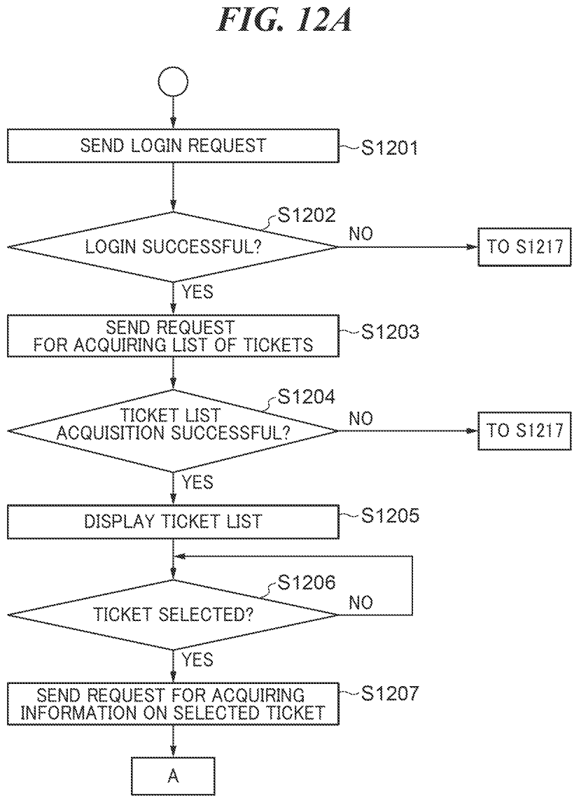

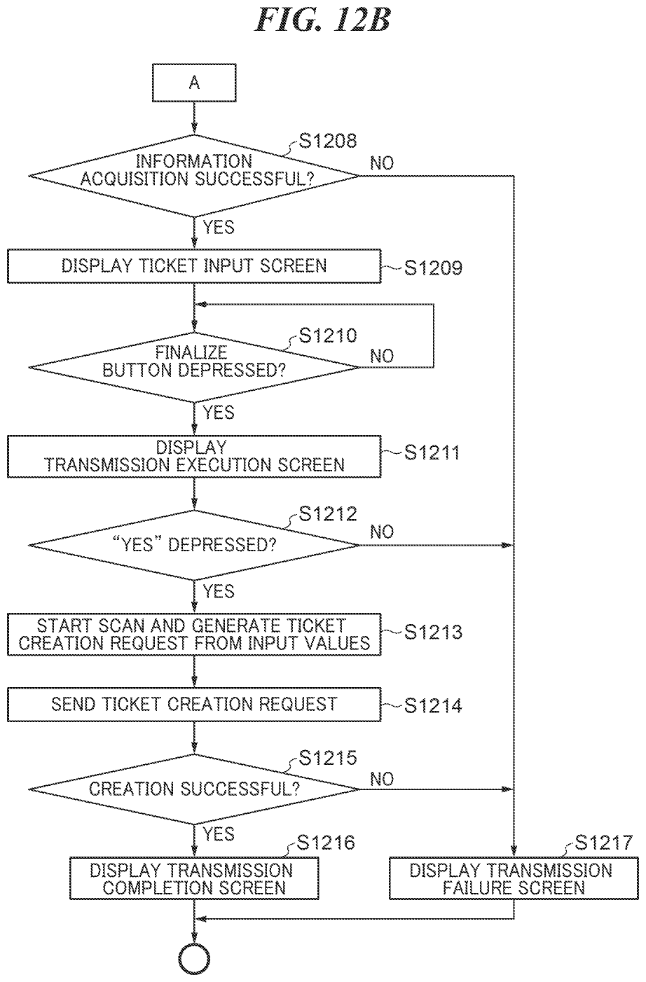

FIGS. 12A and 12B are a flowchart of the ticket creation process performed by the MFP 101 according to the present embodiment. Note that operations (steps) of the present process are performed by the CPU 111 executing a control program loaded from the ROM 112 or the storage 114 into the RAM 113. Steps S1201, S1202, S1210 to S1212, S1216, and S1217 are the same as the steps S901, S902, S906 to S908, S912, and S913, respectively, and hence description thereof is omitted.

Referring to FIG. 12A, in a step S1203, the CPU 111 displays the ticket selection screen 1101 in accordance with a user depression of the ticket creation key 502 in the step S1201. Then, in a case where the existing ticket 1102b is depressed on the ticket selection screen 1101 by the user, the CPU 111 executes transmission of a request for acquiring a list of tickets which the user registered to the requirement management server 300 via the network 100.

In a step S1204, the CPU 111 waits for a response to the request transmitted in the step S1201 from the requirement management server 300 for a predetermined time period. In a case where the response is received, the CPU 111 determines that the acquisition of the list of tickets is successful and proceeds to a step S1205, whereas in a case where no response is received even after the lapse of the predetermined time period, the CPU 111 determines that the acquisition of the list of tickets is unsuccessful and proceeds to the step S1217.

In the step S1205, the CPU displays the existing ticket screen 1103 on which the list of tickets acquired in the step S1204 are reflected, and then proceeds to a step S1206.

In the step S1206, the CPU 111 determines whether or not one of the tickets in the list displayed on the existing ticket screen 1103 is selected by the user. In a case where one of the tickets is selected, the CPU 111 proceeds to a step S1207.

In the step S1207, the CPU 111 executes transmission of a request for acquiring information on the ticket selected in the step S1206 to the requirement management server 300, and then proceeds to a step S1208 in FIG. 12B.

Referring to FIG. 12B, in the step S1208, the CPU 111 waits for a response to the request transmitted in the step S1207 from the requirement management server 300 for a predetermined time period. In a case where the response is received, the CPU 111 determines that the acquisition of the ticket information is successful, and the CPU 111 proceeds to a step S1209, whereas in a case where no response is received even after the lapse of the predetermined time period, the CPU 111 determines that the acquisition of the ticket information is unsuccessful, and the CPU 111 proceeds to the step S1217.

In the step S1209, the CPU 111 displays the existing ticket information input screen 1104 on which the ticket information acquired in the step S1208 is reflected. Note that as described hereinabove with reference to FIG. 11C, the user changes parameter of settings items of the ticket information on the existing ticket information input screen 1104.

In a step S1213, the CPU 111 starts scan processing on a document set on the reading section 118 to thereby acquire image data. Further, the CPU 111 generates a ticket creation request based on the parameters of various setting items changed in the step S1209. Then, the CPU 111 proceeds to a step S1214.

In the step S1214, the CPU 111 attaches image data acquired in the step S1213 to the ticket creation request generated in the same step S1213, as a file, and sends the request to the requirement management server 300. Then, the CPU 111 proceeds to a step S1215.

In the step S1215, the CPU 111 waits for a response notifying completion of creation of a ticket based on the changed parameters of setting items of the existing ticket from the requirement management server 300, for a predetermined time period. In a case where the response is received, the CPU 111 determines that the creation of the ticket, i.e. the changing of the existing ticket, is successful, and proceeds to the step S1216 to display the transmission completion screen, followed by terminating the present process, whereas in a case where no response is received even after the lapse of the predetermined time period, the CPU 111 determines that the creation of the ticket, i.e. the changing of the existing ticket, is unsuccessful, and proceeds to the step S1216 to display the transmission failure screen, followed by terminating the present process.

As described heretofore, according to the present embodiment, it is possible to easily attach new image data to an existing ticket as a file.

In the first and second embodiments, the MFP 101 attaches image data to a new ticket or an existing ticket as a file, but data to be attached to a ticket as a file is not limited to image data. For example, document data or a shot image may be attached.

Further, an apparatus that connects to the requirement management server 300 and transmits data to be attached to a new ticket or an existing ticket as a file is not limited to an MFP, but may be another information processing apparatus, such as a smartphone or a PC.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-089732, filed May 22, 2020, which is hereby incorporated by reference herein in its entirety.

What is claimed is:

1. An information processing apparatus that connects to a server that provides a requirement management service, comprising:
a first acquisition unit configured to acquire input items for creating a ticket, from the requirement management service;
a setting unit configured to set parameters of the acquired setting items in accordance with a user operation;
a generation unit configured to generate a creation request for requesting creation of a ticket on which the parameters set by the setting unit are reflected;
a second acquisition unit configured to acquire data to be attached to the ticket as a file; and
a transmission unit configured to transmit the creation request in a state having the acquired data attached thereto, to the server.

2. The information processing apparatus according to claim 1, further comprising a reading unit configured to perform scan processing on a document to read image data therefrom, and
wherein the data is the image data read by the reading unit.

3. The information processing apparatus according to claim 2, further comprising an execution unit configured to cause the reading unit to execute reading of the image data, and the transmission unit to execute transmission of the creation request.

4. The information processing apparatus according to claim 3, further comprising a registration unit configured to register settings for reading of the image data by the reading unit, execution of which is caused by the execution unit, and settings for transmission of the creation request by the transmission unit, execution of which is caused by the execution unit.

5. An information processing apparatus that connects to a server that provides a requirement management service, comprising:
a first acquisition unit configured to acquire information on an existing ticket from the requirement management server;
a changing unit configured to change parameters of the information on the existing ticket in accordance with a user operation;
a generation unit configured to generate a creation request for requesting creation of a ticket on which the parameters changed by the changing unit are reflected;
a second acquisition unit configured to acquire data to be attached to the ticket as a file; and
a transmission unit configured to transmit the creation request in a state having the acquired data attached thereto, to the server.

6. The information processing apparatus according to claim 5, further comprising a reading unit configured to perform scan processing on a document to read image data therefrom, and
wherein the data is the image data read by the reading unit.

7. The information processing apparatus according to claim 6, further comprising an execution unit configured to cause the reading unit to execute reading of the image data, and the transmission unit to execute transmission of the creation request.

8. The information processing apparatus according to claim 7, further comprising a registration unit configured to register settings for reading of the image data by the reading unit, execution of which is caused by the execution unit, and settings for transmission of the creation request by the transmission unit, execution of which is caused by the execution unit.

9. A network system including:
a server that provides a requirement management service to an information terminal, and
an information processing apparatus that executes transmission of a creation request for creating a ticket to the server,
wherein the information processing apparatus comprises:
a first acquisition unit configured to acquire input items for creating a ticket, from the requirement management service;
a setting unit configured to set parameters of the acquired setting items in accordance with a user operation;
a generation unit configured to generate a creation request for requesting creation of a ticket on which the parameters set by the setting unit are reflected;
a second acquisition unit configured to acquire data to be attached to the ticket as a file; and
a transmission unit configured to transmit the creation request in a state having the acquired data attached thereto, to the server, and
wherein the requirement management service of the server includes creating the ticket in accordance with the creation request and attaching the data to the ticket as a file.

10. A method of controlling an information processing apparatus that connects to a server that provides a requirement management service, comprising:
acquiring input items for creating a ticket, from the requirement management service;
setting parameters of the acquired setting items in accordance with a user operation;
generating a creation request for requesting creation of a ticket on which the set parameters are reflected;
acquiring data to be attached to the ticket as a file; and
transmitting the creation request in a state having the acquired data attached thereto, to the server.

11. A method of controlling an information processing apparatus that connects to a server that provides a requirement management service, comprising:
acquiring information on an existing ticket from the requirement management server;
changing parameters of the information on the existing ticket in accordance with a user operation;
generating a creation request for requesting creation of a ticket on which the changed parameters are reflected;
acquiring data to be attached to the ticket as a file; and
transmitting the creation request in a state having the acquired data attached thereto, to the server.

12. A non-transitory computer-readable storage medium storing a program for causing a computer to execute a method of controlling an information processing apparatus that connects to a server that provides a requirement management service, the method comprising:
acquiring input items for creating a ticket, from the requirement management service;
setting parameters of the acquired setting items in accordance with a user operation;
generating a creation request for requesting creation of a ticket on which the set parameters are reflected;
acquiring data to be attached to the ticket as a file; and
transmitting the creation request in a state having the acquired data attached thereto, to the server.

13. A non-transitory computer-readable storage medium storing a program for causing a computer to execute a method of controlling an information processing apparatus that connects to a server that provides a requirement management service, the method comprising:
acquiring information on an existing ticket from the requirement management server;
changing parameters of the information on the existing ticket in accordance with a user operation;
generating a creation request for requesting creation of a ticket on which the changed parameters are reflected;
acquiring data to be attached to the ticket as a file; and
transmitting the creation request in a state having the acquired data attached thereto, to the server.
